(19) United States
(12) Patent Application Publication
(10) Pub. No.: US 2020/0331369 A1
(43) Pub. Date: Oct. 22, 2020

(54) Unicouple Based Flexible Thermoelectric System

(71) Applicant: Magna Seating Inc, Aurora (CA)

(72) Inventors: Jason Davis, Commerce Township, MI (US); Matthew T Cook, Commerce Township, MI (US); Artur Stepanov, Auburn Hills,, MI (US)

(21) Appl. No.: 16/760,220

(22) PCT Filed: Nov. 1, 2018
(86) PCT No.: PCT/US2018/058687

§ 371 Date: Apr. 29, 2020

Related U.S. Application Data
(60) Provisional application No. 62/579,910, filed on Nov. 1, 2017.

(51) Int. Cl. B60N 2/56; B60N 2/70; F25B 21/04

(52) U.S. Cl. CPC B60N 2/5685; B60N 2/70; F25B 2321/0251; F25B 21/04; B60N 2/5621

(57) ABSTRACT

A unicouple based thermoelectric system comprises a thermoelectric circuit integrated into a cellular foam seat pad. The foam seat pad comprises an upper foam layer and a main foam layer. The thermoelectric circuit comprises a plurality of unicouples with heat sinks which may be pressed through insertion holes in the upper foam into airflow channels in the main foam. The upper foam seals the air channels from leakage which improves the airflow across the heat sinks. Further, the upper foam may be interlocked with the main foam. Alternatively, the upper foam may comprise the insertion holes and a portion of the airflow channels.

### CROSS-REFERENCE TO RELATED APPLICATIONS

This application claims priority to U.S. Provisional Application No. 62/579,910, filed on Nov. 1, 2017.

### BACKGROUND OF THE INVENTION

### 1. Field of the Invention

The present invention relates to a seat assembly in an automotive vehicle having a heating and cooling mechanism or device. More particularly, the invention relates to a unicouple based flexible thermoelectric system assembled with a cellular foam pad, which improves airflow across the heat sinks and reduces leakage from air channels.

### 2. Description of Related Art

Automotive vehicles include one or more automotive seat assemblies having a seat cushion and a seat back for supporting a passenger or occupant above a vehicle floor. It is commonly known to provide heating and/or cooling within a seat assembly for seat occupant comfort. For example, heating and/or cooling thermoelectric elements may be integrated into the seat assembly. One example is a thermoelectric device including an elongated panel formed of thermally isolating material, and having a plurality of thermoelectric elements formed from compacted conductors inside the insulating material and expanded conductors outside the insulating material. Another example is a thermoelectric string woven or assembled into insulating panels. The thermoelectric string may contain spaced apart thermoelectric elements which are thermally and electrically connected to lengths of braided, meshed, stranded, foamed, or otherwise expanded and compressible conductors.

However, current systems rely on heating and/or cooling thermoelectric elements positioned and/or layered within a foam pad. The thermoelectric elements may separate from the foam. Also, channels in the foam to provide airflow across heat sinks may leak air out of the channels. Further, when two layers of foam are used to form a foam pad, the layers may separate under load or over time.

It is desirable, therefore, to provide a unicouple based thermoelectric system within a foam pad having improved airflow across heatsinks. It is also desirable to reduce air leakage out of airflow channels within the foam pad. Further, it is desirable to improve the structural strength between two layers of foam when two layers of foam are used for the seat foam pad.

### SUMMARY OF THE INVENTION

A unicouple based thermoelectric system comprises a thermoelectric circuit integrated into a cellular foam seat pad which may comprise an upper foam layer and a main foam layer. The thermoelectric circuit comprises a plurality of unicouples with heat sinks which may be pressed through insertion holes in the upper foam into airflow channels in the main foam. The upper foam seals the air channels from leakage which improves the airflow across the heat sinks. Further, the upper foam may be interlocked with the main foam. Alternatively, the upper foam may comprise the insertion holes and a portion of the airflow channels.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is top perspective view of a unicouple based flexible thermoelectric system according to a first embodiment of the invention;

FIG. 2 is a top perspective view of a thermoelectric circuit having unicouples according to the embodiment shown in FIG. 1;

FIG. 3 is a bottom perspective view of the thermoelectric circuit having unicouples according to the embodiment shown in FIG. 1;

FIG. 4 is top perspective view of an upper foam assembled with a main foam according to the embodiment shown in FIG. 1;

FIG. 5 is a side view of the thermoelectric circuit having unicouples assembled with the upper foam and the main foam according to the embodiment shown in FIG. 1;

FIG. 6 is a top perspective view of the thermoelectric circuit having unicouples assembled with the upper foam and the main foam according to the embodiment shown in FIG. 1;

FIG. 7 is a top perspective view of an upper foam assembled with a base foam according to a second embodiment of the present invention;

FIG. 8 is a side view of the thermoelectric circuit having unicouples assembled with the upper foam and base foam according to the embodiment shown in FIG. 7;

FIG. 9 is a top perspective view of the thermoelectric circuit having unicouples assembled with the upper foam and the base foam according to the embodiment shown in FIG. 7;

FIG. 10 is a top perspective view of an upper foam assembled with a base foam according to a third embodiment of the present invention;

FIG. 11 is a side view of the thermoelectric circuit having unicouples assembled with the upper foam and base foam according to the embodiment shown in FIG. 10; and

FIG. 12 is a top perspective view of the thermoelectric circuit having unicouples assembled with the upper foam and the base foam according to the embodiment shown in FIG. 10.

### DETAILED DESCRIPTION OF THE EMBODIMENTS

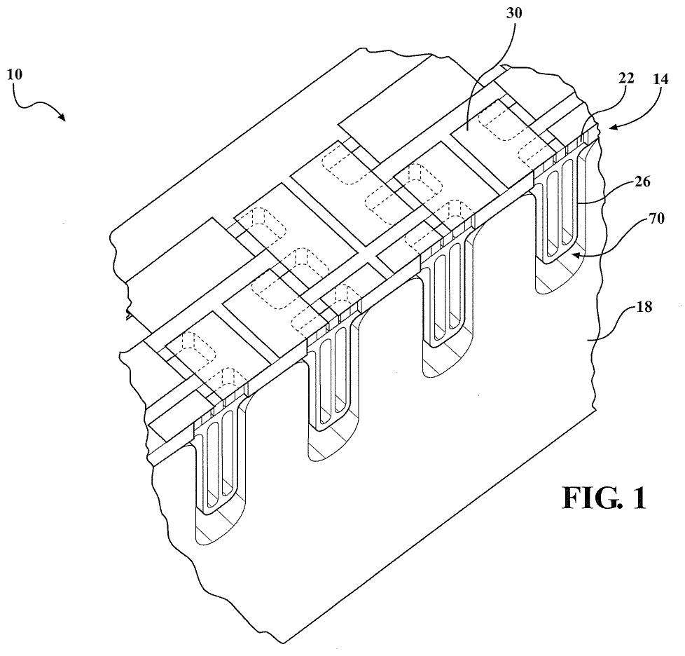

FIGS. 1 to 12 illustrate unicouple based flexible thermoelectric modules, flexible thermoelectric circuit assemblies incorporating the thermoelectric modules, and assemblies of the flexible thermoelectric circuit assemblies with a foam pad according to embodiments described herein. Directional references employed or shown in the description, figures or claims, such as top, bottom, upper, lower, upward, downward, lengthwise, widthwise, left, right, and the like, are relative terms employed for ease of description and are not intended to limit the scope of the invention in any respect. For example, the figures illustrate thermoelectric modules and flexible thermoelectric circuit assemblies with heat sinks extending towards the bottom of the figure. It will be readily apparent that the thermoelectric modules and flexible thermoelectric circuit assemblies according to the present disclosure may be oriented in any direction. Further, cross section views of the thermoelectric modules, flexible thermoelectric circuit assemblies, and foam are shown to illustrate their layers and components, but such views are not necessarily to scale. Referring to the Figures, like numerals indicate like or corresponding parts throughout the several views.

The thermoelectric modules described herein are discrete cooling and/or heating blocks or components which may be mounted to a flexible circuit panel to create a flexible thermoelectric circuit assembly. Alternatively, the thermoelectric modules may be electrically connected with wires, adhesives, foils, etc. to create a flexible thermoelectric circuit assembly. Each thermoelectric module is rigid to protect the thermoelectric materials contained therein, but the distribution of several thermoelectric modules over a flexible circuit panel results in a flexible thermoelectric circuit assembly. The flexible circuit panel may be sized and shaped to target a specific cooling and/or heating application. The flexible circuit panel also may be configured to support suitable numbers and locations or patterns of thermoelectric modules electrically connected in series and/or in parallel to achieve the desired thermoelectric performance.

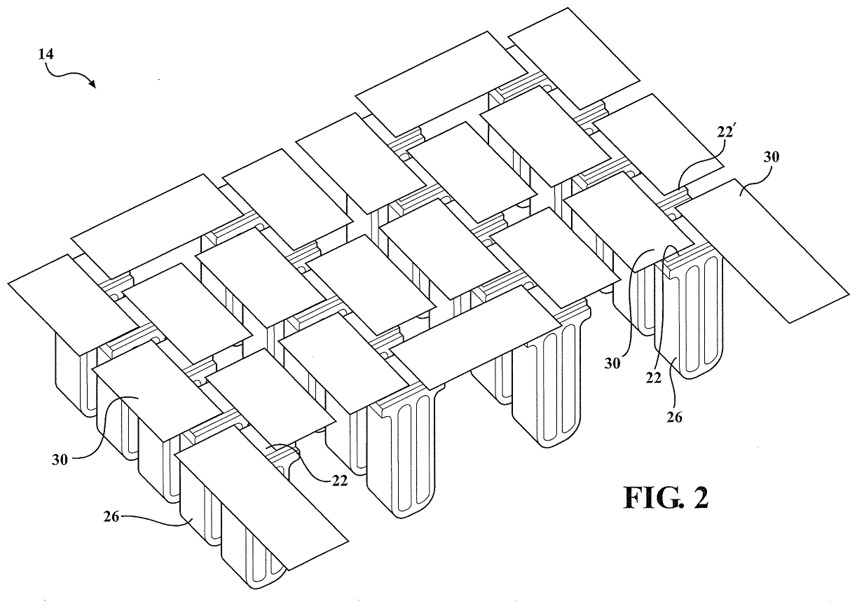

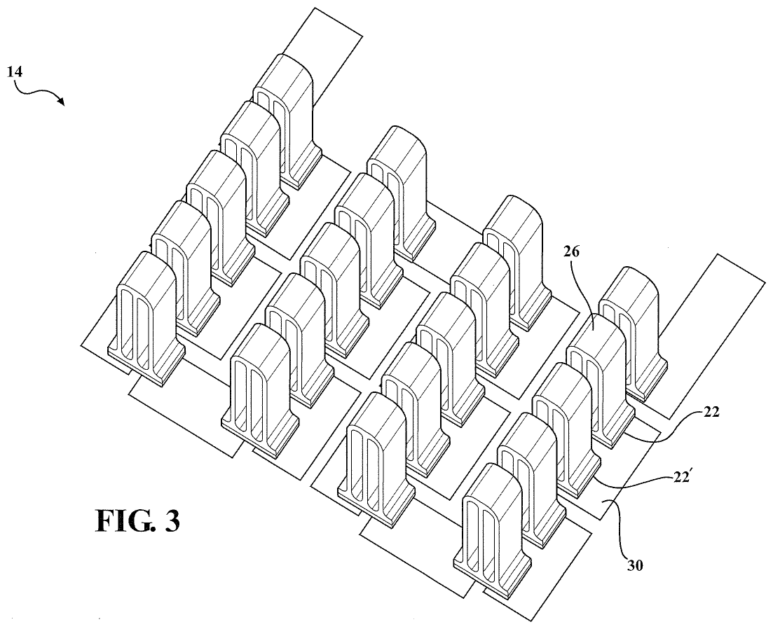

FIG. 1 illustrates a top perspective view of a unicouple based flexible thermoelectric system 10 according to one embodiment of the present disclosure. The unicouple based flexible thermoelectric system 10 provides a way to heat or cool an automotive seat (not shown) for use in an automotive vehicle. The unicouple based flexible thermoelectric system 10 comprises, in part, a thermoelectric circuit 14 assembled with a foam pad 18. As shown in FIGS. 2 and 3, the thermoelectric circuit 14 comprises a plurality of unicouples 22, each of which may be thermally coupled to a heat sink 26. A conductor 30 electrically connects each unicouple 22 to an adjacent unicouple 22′. A plurality of unicouples 22, 22′ electrically interconnected in series by conductors 30 forms the thermoelectric circuit 14 of unicouples 22, 22′. Alternatively, the plurality of unicouples 22, 22′ may be electrically interconnected in parallel and/or a combination of series and parallel connections. An example of a suitable thermoelectric circuit 14 is described in PCT application PCT/US2018/017409, filed Feb. 8, 2018, the entire disclosure of which is hereby incorporated by reference herein.

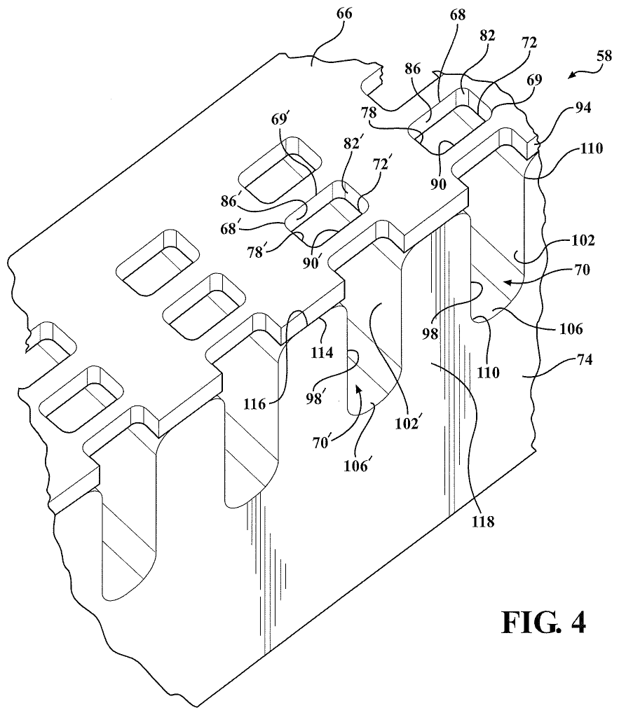

The thermoelectric circuit 14 comprising a plurality of unicouples 22, 22′ may be integrated into a seat foam pad 58 as described according to the embodiments of the present disclosure as generally shown in the Figures. One embodiment of the seat foam pad 58 of the present disclosure is illustrated in FIG. 4. The seat foam pad 58 comprises an upper foam 66 having a plurality of insertion holes 68, 68′ adhered to a main foam 74 having a plurality of airflow channels 70, 70′. Each of the plurality of insertion holes 68, 68′ may comprise a generally rectangular inlet opening 69, 69′, a generally rectangular outlet opening 72, 72′, opposing side walls 78, 82, 78′, 82′ and opposing forward and rear walls 86, 90, 86′, 90′. However, individual insertion holes 68, 68′ may have any shape and dimensions suitable for an intended application including oval, tapered, stepped, and other shapes and sizes. Further, the upper foam 66 may have a uniform thickness 94, or may have a variety of thicknesses in specific areas of the upper foam 66 as suitable for an intended application. The insertion holes 68, 68′ may be generally uniformly distributed across the surface of the upper foam 66 or may be positioned farther apart, closer together, and/or in a uniform or non-uniform pattern as suitable for an intended application. Generally, the individual insertion holes 68, 68′ may align with airflow channels 70, 70′ within the main foam 74 when the upper foam 66 is assembled and/or adhered with the main foam 74.

As shown in FIG. 4, individual airflow channels 70, 70′ may comprise generally opposing side walls 98, 102, 98′, 102′ and a channel base 106, 106′. An upper wall 114 extends between an upper edge of adjacent channel side walls 98, 102′ such that the adjacent channel side walls 98, 102′ and the upper wall 114 form foam ridges or fingers 118 with each foam finger 118 separating adjacent airflow channels 70, 70′. Adjacent surfaces 102, 106, 98, 114 may join at generally right angles and/or may have tapered or curved intersecting portions 110. When assembled, the upper wall surface 114 of the main foam 74 may be joined and/or adhered to a bottom surface 116 of the upper foam 66.

Adjacent airflow channels 70, 70′ and foam fingers 118 may have a generally rounded contour blending each surface towards an adjacent surface. Likewise, the individual airflow channels 70, 70′ and the foam fingers 118 are shown in FIG. 4 having generally “U” shaped contours extending in a linear longitudinal direction and generally parallel with the adjacent airflow channel 70, 70′ and the foam finger 118. However, the individual airflow channels 70 and foam fingers 118 may have any shape, spacing, and/or orientation suitable for an intended application. For example, the airflow channels 70 and the foam fingers 118 may have rectangular shapes and/or may extend in a circular or curved longitudinal direction. Optionally, individual airflow channels 70 may be interconnected to adjacent airflow channels 70′ if desired for an intended application. While not shown in the Figures, multiple unicouples 22, 22′ with heat sinks 26 may be aligned within in a single airflow channel 70 in a transverse direction of the airflow channel 70. For example, an individual airflow channel 70 may have sufficient width to accommodate more than one heat sink 26 in a transverse direction as well as sufficient length to accommodate more than one heat sink 26 in a longitudinal direction.

According to the first embodiment of the present disclosure, the upper foam 66 and the main foam 74 may comprise conventional polyurethane foam having densities suitable for an intended application. The upper foam 66 and the main foam 74 may have different densities, similar densities, and/or may be comprised of different foam materials. Likewise, any suitable adhesive may be used to adhere the upper foam 66 with the main foam 74.

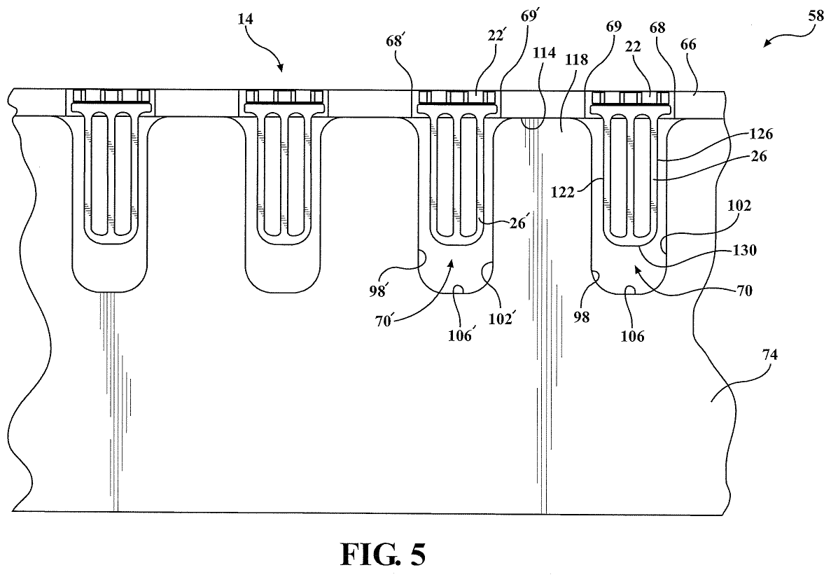

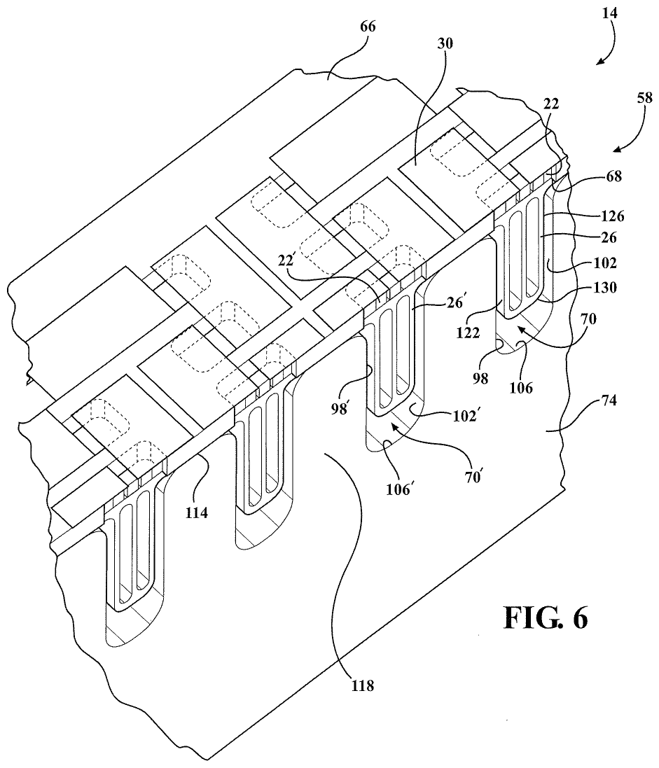

FIGS. 5 and 6 illustrate a side view and a top perspective view, respectively, of the thermoelectric circuit 14 assembled with the foam pad 58 according to one embodiment of the present disclosure. The thermoelectric circuit 14 containing the plurality of unicouples 22 may be integrated into the seat foam pad 58 by pressing the unicouples 22 with heat sinks 26 through the insertion holes 68 in the upper foam 66 and into the airflow channels 70 in the main foam 74. Generally, the unicouples 22 may be positioned within, above, below, and/or partially within the insertion holes 68 in the upper foam 66 after the unicouples 22 are inserted through the insertion holes 68. Each airflow channel 70 is generally sized such that the width and depth of the airflow channel 70 is greater than the width and length of an individual heat sink 26. Thus, when the heat sink 26 is pressed into the airflow channel 70, there is airflow space between the heatsink outer walls 122, 126, 130 and adjacent airflow channel walls 98, 102, 106. Optionally, adhesive may be used to enhance the connection of the thermoelectric circuit 14 with the upper foam 66.

Referring to FIGS. 4-6, the airflow channels 70 in the main foam 74 allow airflow across and/or through the heat sinks 26 to cool the hot side of the unicouples 22. The upper foam 66 seals the airflow channels 70 from leakage. The insertion holes 68 in the upper foam 66 allow the heat sinks 26 to be pressed into the airflow channels 70. Adhesive optionally applied between the upper foam 66 and the main foam 74 may reduce airflow leakage from the airflow channels 70 around the edges of the unicouples 22.

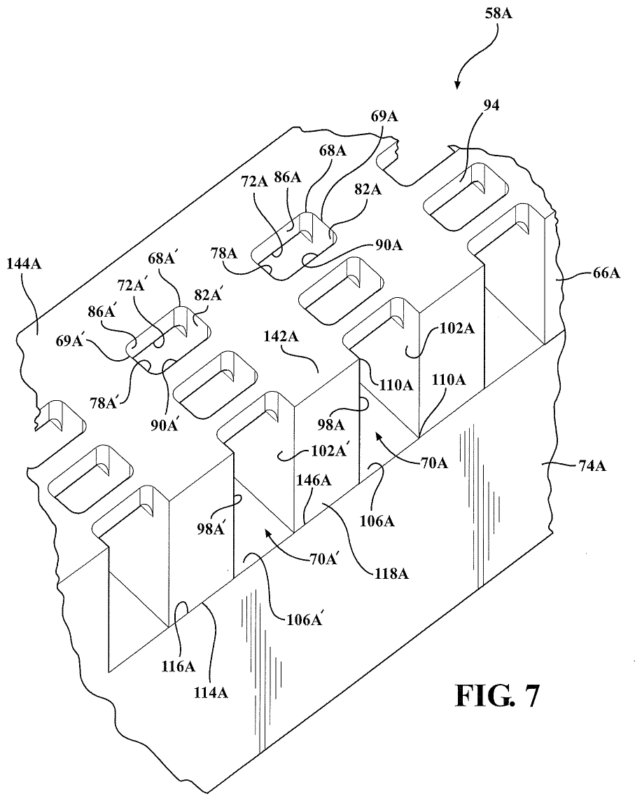

A second embodiment of the integration of a thermoelectric circuit 14A into a seat foam pad 58A is generally shown in FIGS. 7-9. FIG. 7 illustrates a top perspective view of the seat foam pad 58A comprising an upper foam 66A assembled with a base foam 74A according to the second embodiment of the present disclosure. Airflow channels 70A, 70A′ and insertion holes 68A, 68A′ may be integrated into the upper foam 66A. A bottom portion 106A, 106A′ of each of the plurality of airflow channels 70A, 70A′ may be formed by an upper surface 114A of the base foam 74A. Further, a bottom surface 116A of the upper foam 66A may be generally flush with an upper surface 114A of the base foam 74A when the upper foam 66A is assembled with the base foam 74A. Airflow channel sidewalls 98A, 102A, 98A′, 102A′ may be formed within the upper foam 66A. The sidewalls 98A, 102A, 98A′, 102A′ may abut adjacent surfaces with generally a right angle corner 110A, or alternatively, the corners 110A may have a radius, bevel, taper, or other contours suitable for an intended application.

Between each of the adjacent airflow channels 70A, 70A′ is a foam partition wall 118A as shown in FIG. 7. The foam partition wall 118A extends between one sidewall 102A′ of the airflow channel 70A′ and an adjacent sidewall 98A of the airflow channel 70A. The partition walls 118A further comprise an upper surface 142A which may form a portion of an upper surface 144A of the upper foam 66A. The partition walls 118A comprise a bottom wall surface 146A extending between a lower end of adjacent channel sidewalls 102A′, 98A. As exemplified by FIG. 7, the bottom wall surface 146A may be adhered or joined by other known means with the upper surface 114A of the base foam 74A. The plurality of foam partition walls 118A may have a generally rectangular elongated shape as shown in FIG. 7. However, other shapes of foam partition walls 118A suitable for an intended application may be used.

Similar to the first embodiment shown in FIGS. 4-6, each of the plurality of insertion holes 68A, 68A′ may comprise a generally rectangular opening inlet opening 69A, 69A′, a generally rectangular outlet opening 72A, 72A′, opposing side walls 78A, 82A, 78A′, 82A′, and opposing forward and rear walls 86A, 90A, 86A′, 90A′. However, individual insertion holes 68A, 68A′ may have any shape and dimensions suitable for an intended application including round, oval, tapered, stepped, and other shapes and sizes.

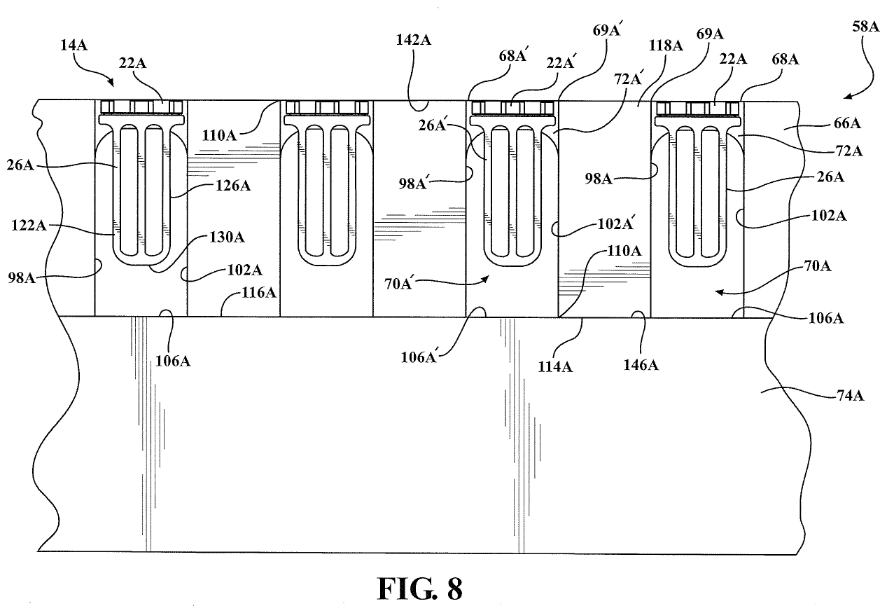

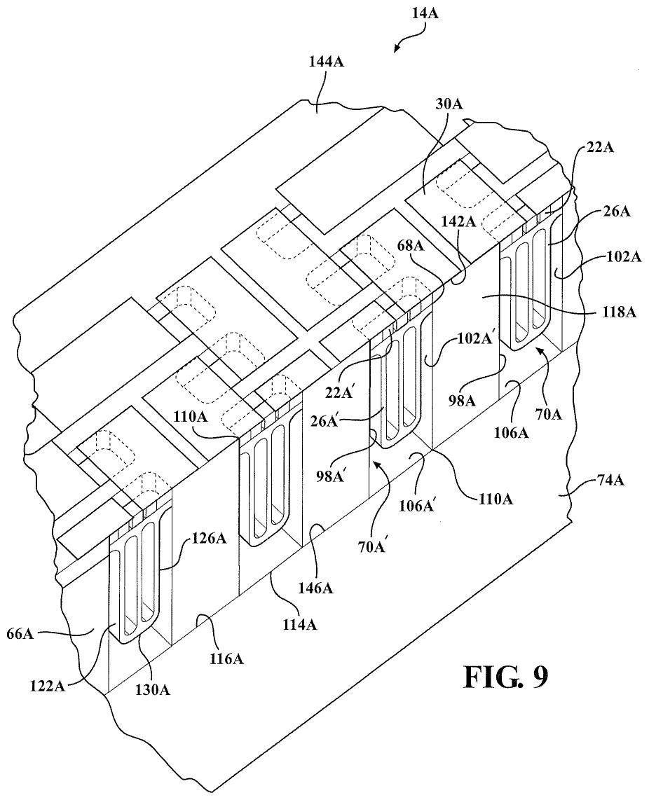

FIGS. 8 and 9 illustrate a side view and a top perspective view, respectively, of the thermoelectric circuit 14A assembled with the foam pad 58A according to the second embodiment of the present disclosure. The thermoelectric circuit 14A containing the plurality of unicouples 22A may be integrated into the seat foam pad 58A by pressing and/or inserting the unicouples 22A with heat sinks 26A through the insertion holes 68A in the upper foam 66A and into the airflow channels 70A in the upper foam 66A. Generally, the unicouples 22A may be positioned within, above, below, and/or partially within the insertion holes 68A in the upper foam 66A after the unicouples 22A are inserted through the insertion holes 68A.

Each airflow channel 70A is generally sized such that the width and depth of the airflow channel 70A is greater than the width and length of an individual heat sink 26A. Thus, when the heat sink 26A is pressed into the airflow channel 70A, there is airflow space between the heatsink outer walls 122A, 126A, 130A and adjacent airflow channel walls 98A, 102A, 106A. The airflow channels 70A in the upper foam 66A allow airflow across and/or through the heat sinks 26A to cool the hot side of the unicouples 22A. The upper foam 66A seals the airflow channels 70A from leakage. Optionally, adhesive may be applied between the thermoelectric circuit 14A and the upper foam 66A to enhance the bond with the upper foam 66A and/or improve the seal to prevent air leakage around the unicouple 22A out of the airflow channel 70A.

According to the second embodiment of the present disclosure, the upper foam 66A and the base foam 74A may comprise conventional polyurethane foam having densities suitable for an intended application. The upper foam 66A and the base foam 74A may have different densities, similar densities, and/or may be comprised of different foam materials. The upper foam 66A and the base foam 74A may comprise any suitable foam for an intended application. Likewise, any suitable adhesive may be used to adhere the upper foam 66A with the base foam 74A.

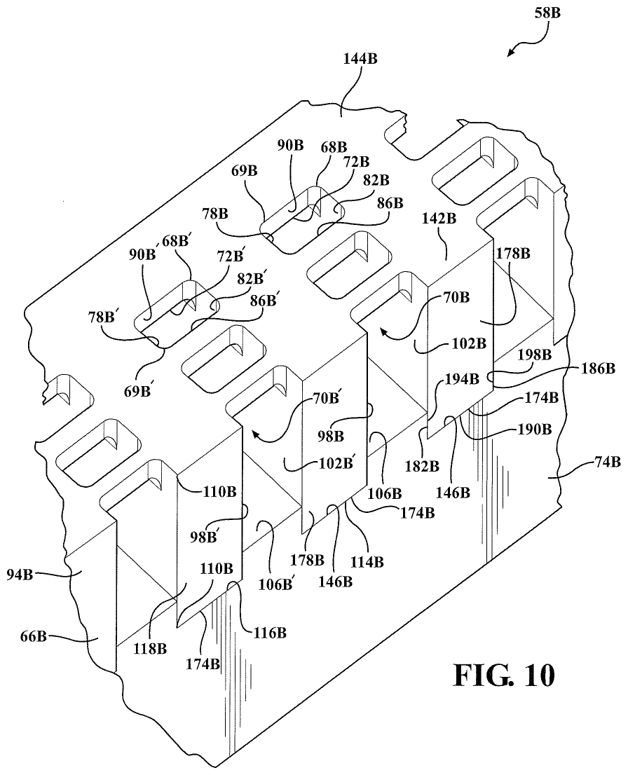

A third embodiment of the present disclosure integrating a thermoelectric circuit 14B into a seat foam pad 58B is generally shown in FIGS. 10-12. FIG. 10 illustrates a top perspective view of the seat foam pad 58B which comprises an upper foam 66B assembled to a base foam 74B. Airflow channels 70B, 70W and insertion holes 68B, 68W may be partially or fully integrated into the upper foam 66B. Opposing airflow channel sidewalls 98B, 102B, 98B′, 102W may be formed within the upper foam 66B. The sidewalls 98B, 102B, 98W, 102W may abut adjacent surfaces with generally a right angle corner 110B, or alternatively, the corners 110B may have a radius, bevel, taper, or other contours suitable for an intended application. Partition walls 118B in the upper foam 66B separate each of a plurality of adjacent airflow channels 70B, 70W. An exemplary foam partition wall 118B extends between one sidewall 102W of the airflow channel 70W and an adjacent sidewall 98B of the airflow channel 70B. The partition walls 118B may further comprise an upper surface 142B which may form a portion of an upper surface 144B of the upper foam 66B. The partition walls 118B may comprise a bottom wall surface 146B extending between a lower end of adjacent channel sidewalls 102W, 98B.

As generally shown in FIG. 10, a bottom portion 106B, 106B′ of each of the plurality of airflow channels 70B, 70B′ may be formed by an upper surface 106B, 106W of the base foam 74B. The base foam 74B may further comprise one or more recessed channels 174B which are configured to receive one or more base portions 178B of the partition walls 118B. The recessed channels 174B comprise opposing side walls 182B, 186B and a channel bottom wall 190B. The base portion 178B of the partition wall 118B comprises opposing sidewall portions 194B, 198B, and the base wall 146B. When the base portion 178B of the partition wall 118B is inserted into the recessed channel 174B, the bottom wall surface 146B of the partition wall 118B may be adhered or joined by other known means with an upper surface 114B of the base foam 74B. Further, the lower portions of the sidewalls 194B, 198B of the partition walls 118B may be adhered to the recessed channel walls 182B, 186B when the base portion 178B of the partition walls 118B are inserted into the recessed channels 174B. The plurality of foam partition walls 118B may have a generally rectangular elongated shape as shown in FIG. 10. However, other shapes of foam partition walls 118B suitable for an intended application may be used.

In the second embodiment of the present disclosure, the lower surface 116A of the upper foam 66A, the lower surface 146A of the foam partition walls 118A, the upper surface of the base foam 74A forming the airflow channel 70A bottom wall 106A, and the upper surface 114A of the base foam 74A are generally aligned in a transverse direction as shown in FIG. 7. In contrast, in the third embodiment of the present disclosure, the upper foam 66B may interlock into the base foam 74B such that base portions 178B of the foam partition walls 118B are inserted into the recessed channels 174B in the base foam 74B. Referring to FIG. 10, a lower surface 116B of the upper foam 66B and the airflow channel 70B, 70B′ bottom portions 106B, 106W are offset from each other by the depth of the recessed channels 178B when the upper foam 66B is assembled with the base foam 74B. The structural bond between the upper foam 66B and the base foam 74B may be increased by the interlocking of the upper foam 66B with the base foam 74B. Further, adhesive may be applied between the upper foam 66B and the base foam 74B to increase the bond between the base portions 178B of the foam partition walls 118B and the recessed channels 174B in the base foam 74B.

The base foam 74B and/or the upper foam 66B may have one or more channels, notches, recessed areas, protrusions, ribs, or elongated features (not shown) such that a bottom surface 116B of the upper foam 66B may interlock into an upper surface 106B of the base foam 74B or alternatively, the base foam 74B may interlock into the upper foam 66B.

Also, as shown in FIG. 10, the upper foam 66B may have a plurality of insertion holes 68B, 68W distributed across the upper surface 144B of the upper foam 66B. Each of the plurality of insertion holes 68, 68W may comprise a generally rectangular inlet opening 69B, 69B′, a generally rectangular outlet opening 72B, 72W, opposing side walls 78B, 82B, 78W, 82W, and opposing forward and rear walls 86B, 90B, 86B′, 90B′. However, individual insertion holes 68B, 68W may have any shape and dimensions suitable for an intended application including oval, tapered, stepped, and other shapes and sizes. Likewise, individual insertion holes 68B, 68B′ may be of uniform shape and size or may comprise one or more shapes and sizes. The insertion holes 68B, 68W may be generally uniformly distributed across the surface of the upper foam 66B or may be positioned farther apart, closer together, and/or in a uniform or non-uniform pattern as suitable for an intended application. Generally, the insertion holes 68B, 68B′ may align with airflow channels 70B, 70B′ within the upper foam 66B.

According to the third embodiment of the present disclosure, the upper foam 66B and the base foam 74B may comprise conventional polyurethane foam having densities suitable for an intended application. The upper foam 66B and the base foam 74B may have different densities, similar densities, and/or may be comprised of the same or different foam materials. The upper foam 66B and the base foam 74B may comprise any suitable foam for an intended application. Likewise, any suitable adhesive may be used to adhere the upper foam 66B with the base foam 74B. Further, the upper foam 66B may have a uniform thickness 94B, or may have a variety of thicknesses in specific areas of the upper foam 66B as suitable for an intended application.

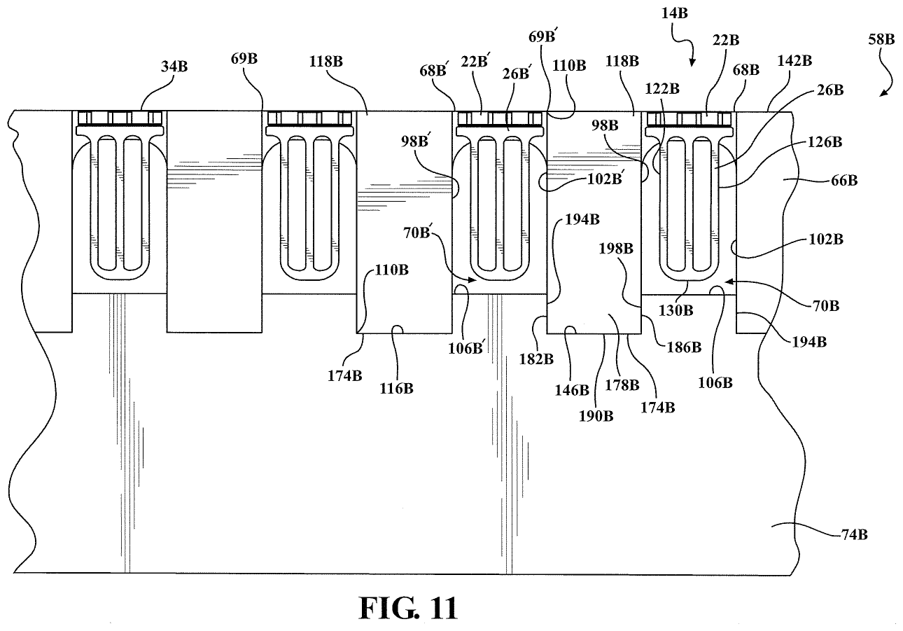

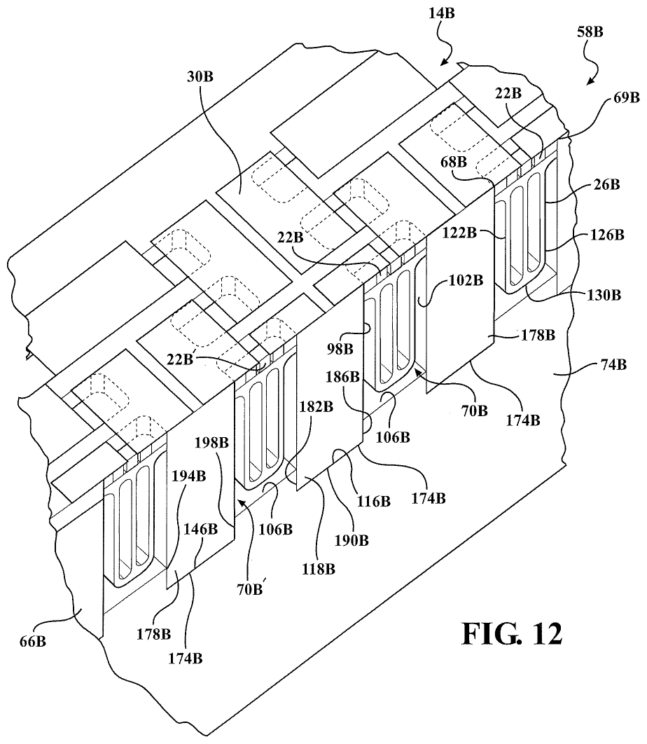

FIGS. 11 and 12 illustrate a side perspective view and a top perspective view, respectively, of the thermoelectric circuit 14B assembled with the foam pad 58B according to the third embodiment of the present disclosure. The thermoelectric circuit 14B containing the plurality of unicouples 22B may be integrated into the seat foam pad 58B by pressing and/or inserting the unicouples 22B with heat sinks 26B through the insertion holes 68B in the upper foam 66B and into the airflow channels 70B in the upper foam 66B. Generally, the unicouples 22B may be positioned within, above, below, and/or partially within the insertion holes 68B in the upper foam 66B after the unicouples 22B are inserted into the insertion holes 68B.

Each airflow channel 70B is generally sized such that the width and depth of the channel 70B is greater than the width and length of an individual heat sink 26B. Thus, when the heat sink 26B is pressed into the airflow channel 70B, there is airflow space between the heat sink outer walls 122B, 126B, 130B and adjacent airflow channel walls 98B, 102B, 106B. The airflow channels 70B in the upper foam 66B allow airflow across and/or through the heat sinks 26B to cool the hot side of the unicouples 22B. The upper foam 66B seals the airflow channels 70B from leakage. Optionally, adhesive may be used to enhance the connection of the thermoelectric circuit 14B with the upper foam 66B. The adhesive may reduce airflow leakage from the airflow channels 70B around the edges of the unicouples 22B.

One benefit of the unicouple based flexible thermoelectric system of the present disclosure is improved airflow across the heat sinks positioned in the airflow channels. A second benefit is reduced airflow leakage out the airflow channels around the unicouples. An additional benefit is an improved structural bond between layers of foam by interlocking a first layer of foam with a second layer of foam. Further, an improved assembly with a foam pad is obtained by inserting the heat sink and/or unicouple into and/or through an insertion hole such that the heat sink is positioned within an airflow channel.

The invention has been described in an illustrative manner, and it is to be understood that the terminology, which has been used, is intended to be in the nature of words of description rather than of limitation. Many modifications and variations of the present invention are possible in light of the above teachings. It is, therefore, to be understood that within the scope of the appended claims, the invention may be practiced other than as specifically described.

What is claimed is:

1. A unicouple based flexible thermoelectric system for an automotive seat assembly, said unicouple based flexible thermoelectric system comprising:
a flexible thermoelectric circuit assembly comprising at least one unicouple electrically connected to a conductor;
said at least one unicouple being thermally coupled to a heat sink; and
a cellular foam pad having at least one airflow channel passing through a portion of said foam pad;
said foam pad comprising at least one insertion hole aligned with said at least one airflow channel;
wherein said at least one unicouple being matingly engaged with said at least one insertion hole and said heat sink being positioned at least partially within said at least one airflow channel.

2. The system as set forth in claim 2, wherein said foam pad comprises an upper foam assembled with a main foam; and
wherein said at least one insertion hole passes through at least a portion of the upper foam.

3. The system as set forth in claim 3, wherein said main foam comprises at least a portion of at least one airflow channel.

4. The system as set forth in claim 4, wherein adhesive at least partially adheres said upper foam with said main foam.

5. The system as set forth in claim 5, wherein adhesive at least partially adheres said at least one unicouple with said upper foam.

6. The system as set forth in claim 3, wherein said upper foam comprises at least a portion of said at least one airflow channel.

7. The system as set forth in claim 7, wherein said main foam comprises a lower portion of said at least one airflow channel.

8. The system as set forth in claim 7, wherein said upper foam and said main foam are interlocked when assembled to form said foam pad.

9. A seat pad assembly for an automotive seat, said seat pad assembly comprising:
a flexible thermoelectric circuit assembly comprising at least one unicouple electrically connected to a conductor and thermally connected to a heat sink;
a cellular foam pad having at least one airflow channel passing through a portion of said cellular foam pad and at least one insertion hole having an inlet opening on a first outer surface of said foam pad and an outlet opening aligned with a portion of said at least one airflow channel; and a
said at least one unicouple being matingly engaged with said at least one insertion hole and said heat sink being positioned at least partially within said at least one airflow channel.

10. The seat pad assembly as set forth in claim 11, said cellular foam pad further comprises an upper foam and a base foam; wherein:
said at least one insertion hole passing through a portion of said upper foam; and
said at least one airflow channel passing through a portion of said base foam.

11. The seat pad assembly as set forth in claim 11, said cellular foam pad further comprises an upper foam and a base foam; wherein:
said at least one insertion hole passing through a portion of said upper foam; and
said at least one airflow channel passing through a portion of said upper foam.

12. The seat pad assembly as set forth in claim 13, wherein an upper surface of said base foam forms a lower portion of said at least one airflow channel.

13. The seat pad assembly as set forth in claim 14, wherein said at least one airflow channel comprises a plurality of airflow channels passing through a portion of said upper foam, each pair of airflow channels having a foam wall separating adjacent airflow channels.

14. The seat pad assembly as set forth in claim 15, wherein a lower portion of said foam wall being matingly engaged with a recess channel in said base foam.

15. A unicouple based flexible thermoelectric system for an automotive seat assembly, said unicouple based flexible thermoelectric system comprising:
a flexible thermoelectric circuit assembly comprising at least one unicouple electrically connected to a conductor and thermally connected to a heat sink;
a cellular foam pad comprising a first foam layer adhered to a second foam layer;
said first foam layer comprising at least one insertion hole having an inlet opening on an upper surface of said first foam layer;
said first foam layer comprising sidewall portions of at least two airflow channels separated by a foam wall;
said at least one insertion hole comprising an outlet opening forming a passageway connecting said at least one insertion hole with one of said airflow channels;
wherein said at least one unicouple being matingly engaged with said at least one insertion hole and said heat sink being positioned at least partially within one of said airflow channels.

16. The system as set forth in claim 17, wherein an upper surface of said second foam layer forms a bottom portion of at least one airflow channel.

17. The system as set forth in claim 18, wherein a lower portion of said foam wall being matingly engaged with a recess channel in said second foam layer.

18. The system as set forth in claim 19, wherein said at least one unicouple is adhered with said at least one insertion hole.
